(19) United States
(12) Patent Application Publication
(10) Pub. No.: US 2005/0190653 A1
(43) Pub. Date: Sep. 1, 2005

(54) Method of displaying world time with automatic correction of daylight saving time in a movement

(76) Inventor: Chih Yuh Chen, Taipei (TW)

Correspondence Address: CHIH YUH CHEN, 235 CHUNG-HO BOX 8-24, TAIPEI HSIEN, 235, TW

(21) Appl. No.: 10/788,011

(22) Filed: Feb. 27, 2004

(51) Int. Cl. G04C 11/02

(52) U.S. Cl. 368/21

(57) ABSTRACT

A movement for automatically correcting daylight saving time (DST) comprises a time display unit for displaying time; a central processing unit (CPU) building with a DST calculating program for calculating correct time and displaying on the time display unit; and a time zone adjusting unit installed with 24 time zone segments; as one of the 24 time zone segments is selected. The CPU receives the time zone signals from the time zone adjusting unit and calculated a correct time based on the selected time zone segments and a DST of the selected time zone, and then control the time display unit to display the correct time. Therefore, a user may conveniently adjust the clock movement only once to quickly and automatically show a correct relative time including the DST for a desired time zone.

### FIELD OF THE INVENTION

The present invention relates to a method of displaying a world time with automatic correction of a daylight saving time (DST) in a movement, wherein a correct time including DST effect can be acquired by adjusting once.

### BACKGROUND OF THE INVENTION

Nowadays, a large amount of people must travel through different areas of different time zones. Greenwich mean time (GMT) is used as a worldwide time standard. On the basis of the Greenwich meridian, the globe is divided into 24 time zones (0-24 hrs). Two adjacent time zones have a time difference of one hour. When people travel through one time zone (15 degrees of longitude), a time difference of one hour occurs.

A conventional clock, either a mechanical or an electronic type, shows only the time of one fixed time zone. When the clock is used in a different time zone, it must be adjusted according to the correct time in that time zone, and is therefore inconvenient for use.

Accompany business globalization and the concept of a global village, people need to know times of different areas due to some requirements, such as business requirement, stock information or acquaintance communication. The inventor has realized the demand for a clock that could present every time zone of the world in an easy way at once. In addition, people in utilize Daylight Saving Time (DST) countries (approximately 70 countries utilize DST) need to adjust their clock forward a hour in the first day and backward a hour at the last day. These adjustments somehow bother, therefore inventor considers making DST adjustment automatically.

FIG. 1 shows a clock available from CASIO™ for showing times of different time zones in the world. In that, a rotary disk 92 is installed around a periphery of a time display unit 91 (including a hour hand, a minute hand and a second hand). The rotary disk 92 is circumferentially divided into 24 segments that corresponding to 24 time zones. By turning the rotary disk 92 by one segment, the clock is adjusted to show the time of an adjacent time zone, as shown in FIGS. 2A and 2B. In other words, whenever the rotary disk 92 is turned by one segment, the internal mechanical structure of the clock would move the hour hand forward or backward by one hour to represent the one-hour time difference between the current and the adjacent time zones.

Although the above-described currently commercially available clock for showing world times allows a user to conveniently adjust the time shown by the clock, it does not automatically adjust the clock to show the correct daylight saving time (DST) that is frequently adopted in many countries and areas in the world. In this case, the user has to manually adjust the clock according to the DST announced by the local government.

There has been developed a radio control clock, which emits a radio wave from a base station to a user having a corresponding receiver. While the radio control clock may advantageously show world times, including the DST, it has the problem of dead angles, at where the user could not receive the signal of radio wave emitted from the base station. Moreover, the radio control clock has limited range of use, and is therefore not workable in some places.

Thereby, to get an elevation adjusting device of an auxiliary table plate is a main object of the present invention.

### SUMMARY OF THE INVENTION

Accordingly, the primary object of the present invention is to provide a movement for automatically correcting daylight saving time (DST) which comprises a time display unit for displaying time; a central processing unit (CPU) building with a time difference and DST calculating program for calculating correct time and displaying on the time display unit; and a time zone adjusting unit installed with 24 time zone segments; as one of the 24 time zone segments is selected. The CPU receives the time zone signals from the time zone adjusting unit and calculated a correct time based on the selected time zone section and a DST of the selected time zone, and then control the time display unit to display the correct time. Thereby, a correct time can be got by adjusting once.

Another object of the present invention is to provide a movement for automatically correcting DST, wherein no wireless control signal is used so that it is not confine by the range. Once the setup operation is performed, it is only necessary to adjust a time zone adjusting unit, and then a correct time including the DST effect can be displayed.

Another object of the present invention is to provide a movement for automatically correcting DST, wherein calculation of the DST in the DST calculating program is based on the DST of an area in the time zone which is determined by the nation the area belonged.

A further object of the present invention is to provide a method of displaying a world time with automatic correction of a DST in a movement, in which a DST operation program is included to define the American (US) DST from 02:00 of the first Sunday of April to 02:00 of the last Sunday of October each year, and the European (EUR) DST from 02:00 of the last Sunday of March to 03:00 of the last Sunday of October each year. The clock movement includes a CPU that automatically corrects the time shown on the clock at the beginning or ending time of the DST based on the time zone specified via the time zone adjusting mechanism and information about whether the DST is adopted in that time zone.

A yet object of the present invention is to provide a method of displaying a world time with automatic correction of a DST in a movement, in which a mode control key is included. After a return-to-zero operation is done via the mode control key, the clock movement may be set to a desired time zone (or city). Then, a user may select whether to turn on the DST operational function, and then inputs correct time of the set time zone to complete the setting of correct time.

A still object of the present invention is to provide a method of displaying a world time with automatic correction of a DST in a movement, wherein two contact sets are extended from the CPU. The first contact set includes four contacts, while the second contact set includes six contacts. Through adjustment of the time zone adjusting mechanism, two contacts are separately selected from the two contact sets to contact with each other. In this manner, total 24 different time zone signals may be generated for inputting into the CPU.

A still further object of the present invention is to provide a method of displaying a world time with automatic correction of a DST in a movement, in which an alarm function is included.

A still further object of the present invention is to provide a method of displaying a world time with automatic correction of a DST in a movement, which may be a mechanical clock and includes a CPU capable of operating and controlling a synchronous motor to rapidly turn the hour, the minute, and the second hand to show correct time.

A still further object of the present invention is to provide a digital clock configured for automatic correction of DST, of which the hour, the minute, and the second hand may be rapidly turned to show correct time after an operation of time conducted by a CPU.

The various objects and advantages of the present invention will be more readily understood from the following detailed description when read in conjunction with the appended drawing.

### BRIEF DESCRIPTION OF THE DRAWINGS

FIG. 1 is a perspective view of a world clock in the prior art.

FIGS. 2A and 2B are operational schematic view of the clock illustrated in FIG. 1.

FIG. 3 shows one structure according to one embodiment of the present invention.

FIG. 4 is an operational flow diagram according to one embodiment of the present invention.

FIG. 5 is a contrast table showing the construction of 24 time zones in the time zone adjusting unit of the present invention.

FIG. 6 shows the flow of the operation program of the DST in the present invention.

FIG. 7 is a perspective view of one embodiment of the present invention.

FIG. 8 shows the flow of the alarm function according to the present invention.

FIG. 9 shows a control flow diagram about the correction of time according to the present invention.

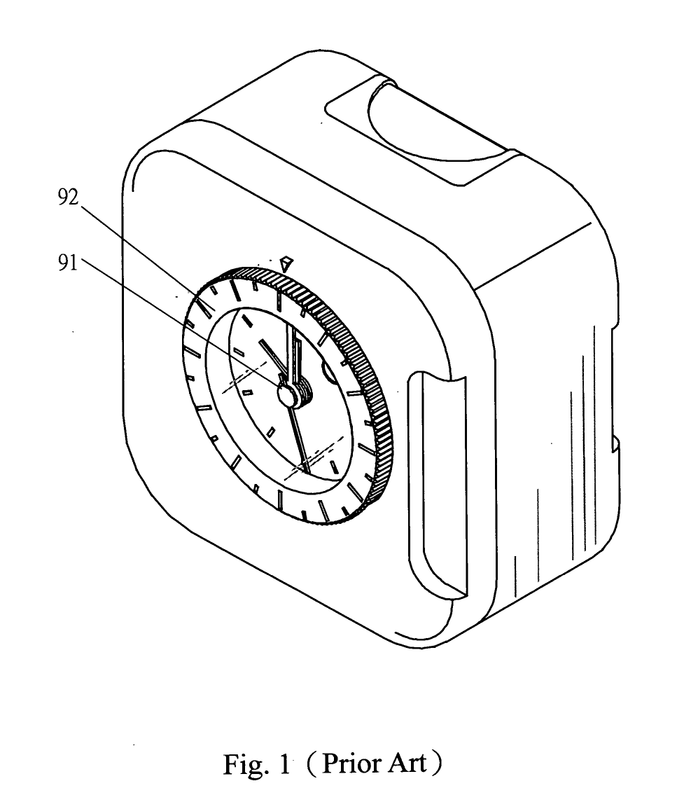

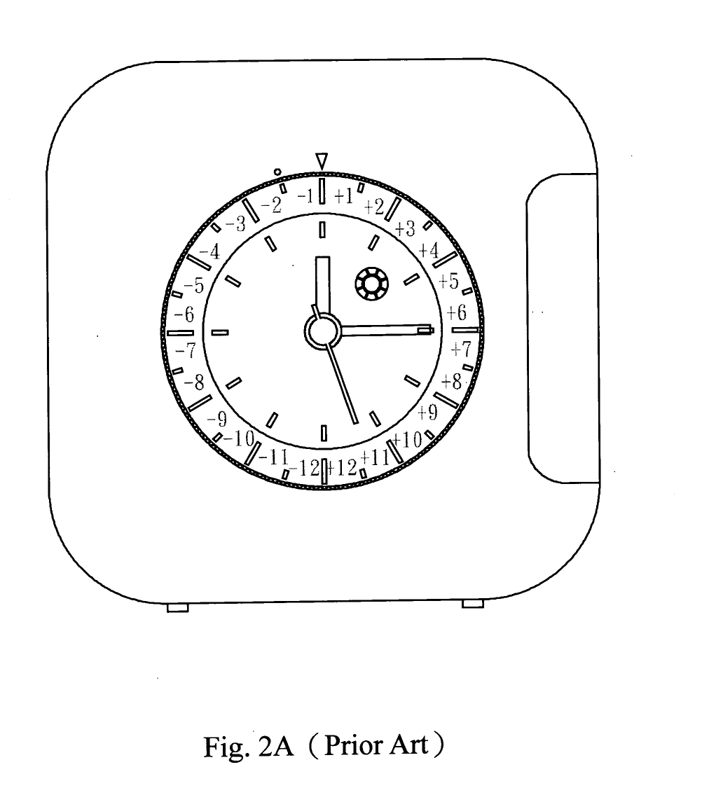

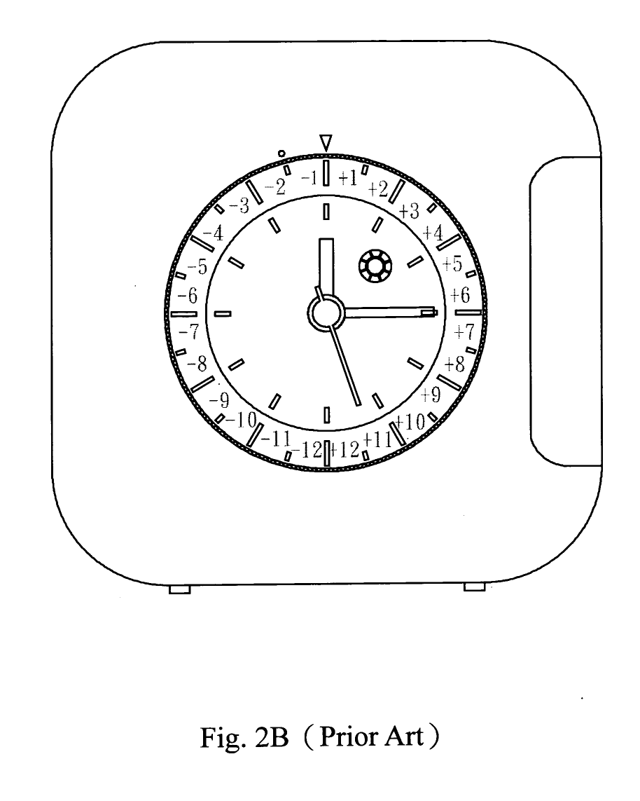

### DETAILED DESCRIPTION OF THE INVENTION

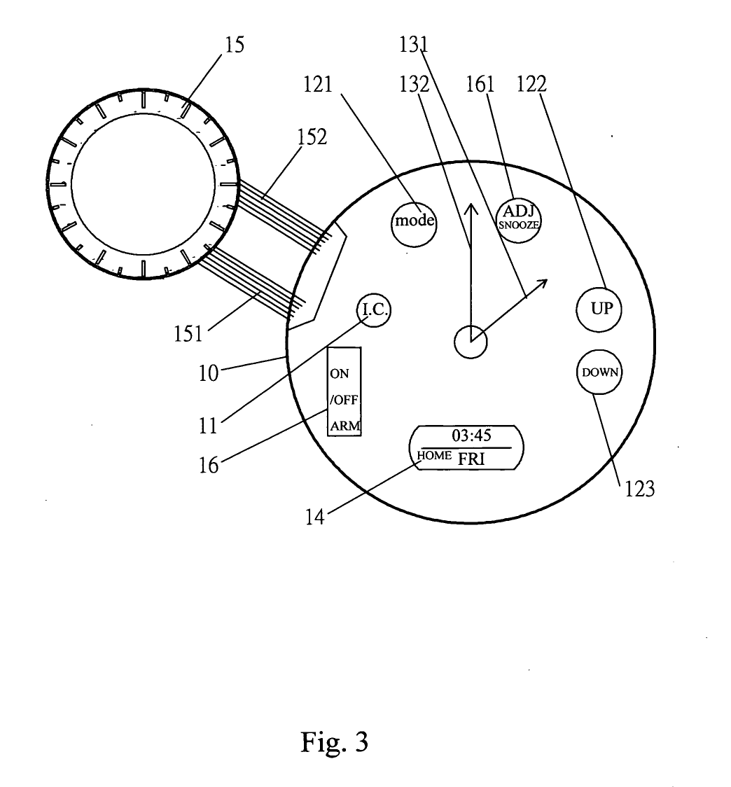

With reference to FIG. 3, the structural schematic view of the present invention is illustrated. A core 10 has a central processing unit (CPU) 11, mode selection keys 121, 122, and 123, a hour hand 131, a minute hand 132, a liquid crystal time display 14, a time zone adjusting unit 15, and an alarm switch 16.

The CPU 11 is a programmable operation unit for controlling mechanical time display unit and liquid crystal time display unit to select a time zone to have a correct time. The CPU 11 has at least two calculation modes, one is a time zone calculation program and the other is a DST calculating program.

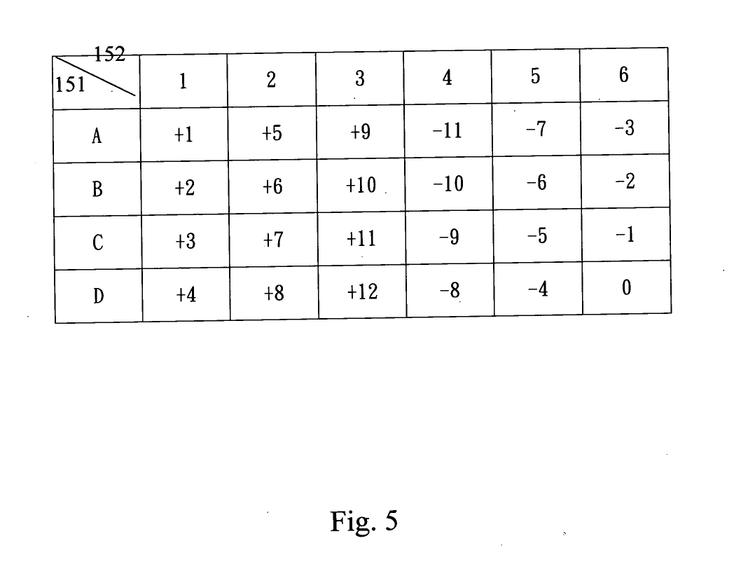

Two contact sets 151, 152 are extended from the CPU 11. One contact set has four contacts, and another has six contacts, which extends into the time zone adjusting unit 15. By adjusting the time zone adjusting unit 15, any two contacts selected from the two contact sets, respectively, contact the time zone adjusting unit so as to form 24 different time zone signals which are then inputted to the CPU 11. Referring to FIG. 5, it is illustrated that one of the four contacts A, B, C and D and one of the six contacts 1, 2, 3, 4, 5, and 6 are in contact with one another so as to from different time zone signals. For example, A-1 is a +1 time zone; D-6 is a 0 time zone; C-6 is a −1 time zone, etc. Totally, there are 24 time zone signals which are inputted to the CPU 11.

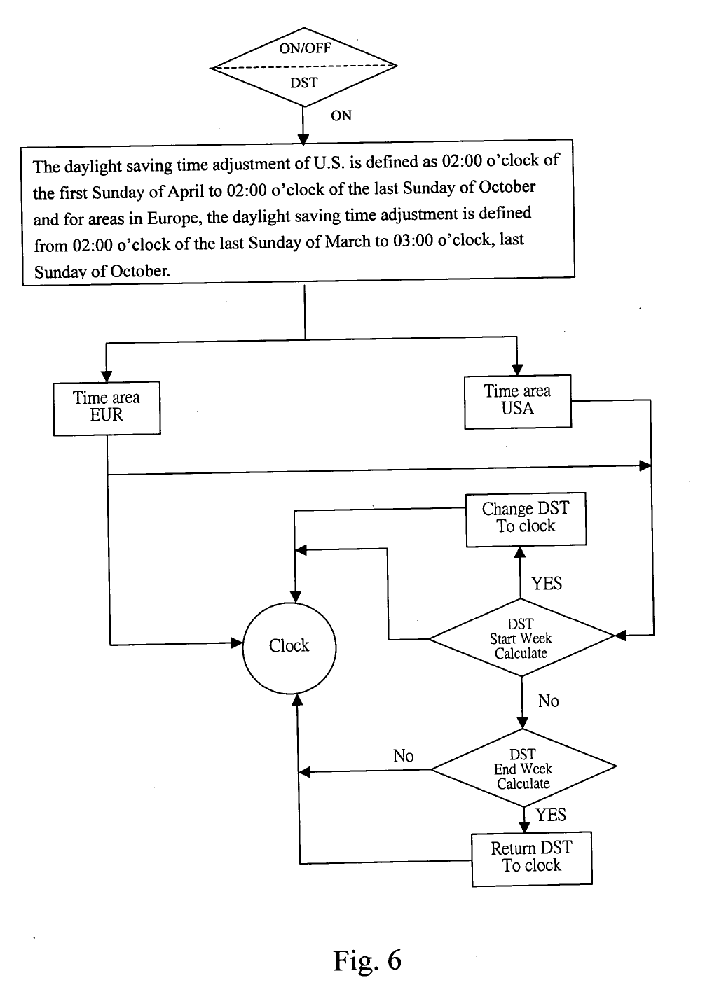

The DST adjusting program of the CPU 11 is shown in the flow of FIG. 6. The program sets the DST adjustment of necessary nations. In the program, the DST adjustment of U.S. is firstly defined as 02:00, the first Sunday of April to 02:00 of the last Sunday of October. In Europe, the DST adjustment is defined from 02:00 o'clock of the last Sunday of March to 03:00 o'clock of the last Sunday of October. The CPU 11 calculates the DST adjustment as the time zone is within a period of DST adjustment so as to add the adjusting time to a contrast time without performing DST adjustment. The movable mechanic display unit (hands) and the liquid crystal time display 14 serve to indicate correct time.

If the selected time zone is not in the period of DST adjustment, the time is directly indicated.

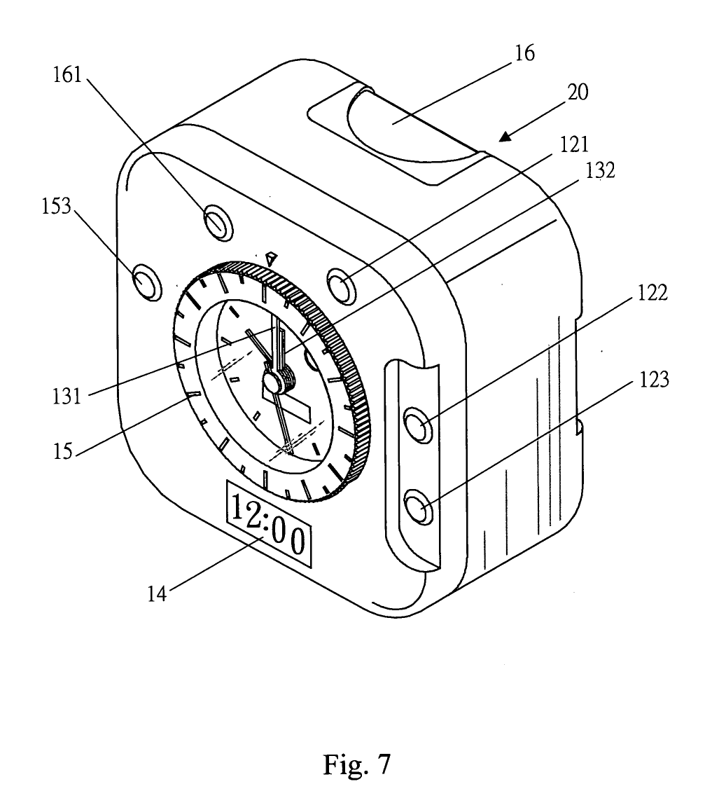

Referring to FIG. 7, an appearance of a clock according to one embodiment of the present invention is illustrated. The whole core 10 is installed in a casing 20. The mode selection keys include a mode key 121, an upward key 122 and a downward key 123. The mechanical time display units 131, 132 are installed at a front center of the casing 20 and a periphery thereof has the time zone adjusting unit 15. Basically, the time zone adjusting unit 15 is a disk rotatable step by step. Twenty four scales are shown on the time zone adjusting unit 15 for representing 24 time zones. The setup key 153 serves to input signals into the CPU 11 by pressing the setup key 153 when the time zone adjusting unit 15 rotates to a desired time zone. Thereby, when the time zone adjusting unit 15 is rotated by mistake, the liquid crystal time display 14 displays data digitally.

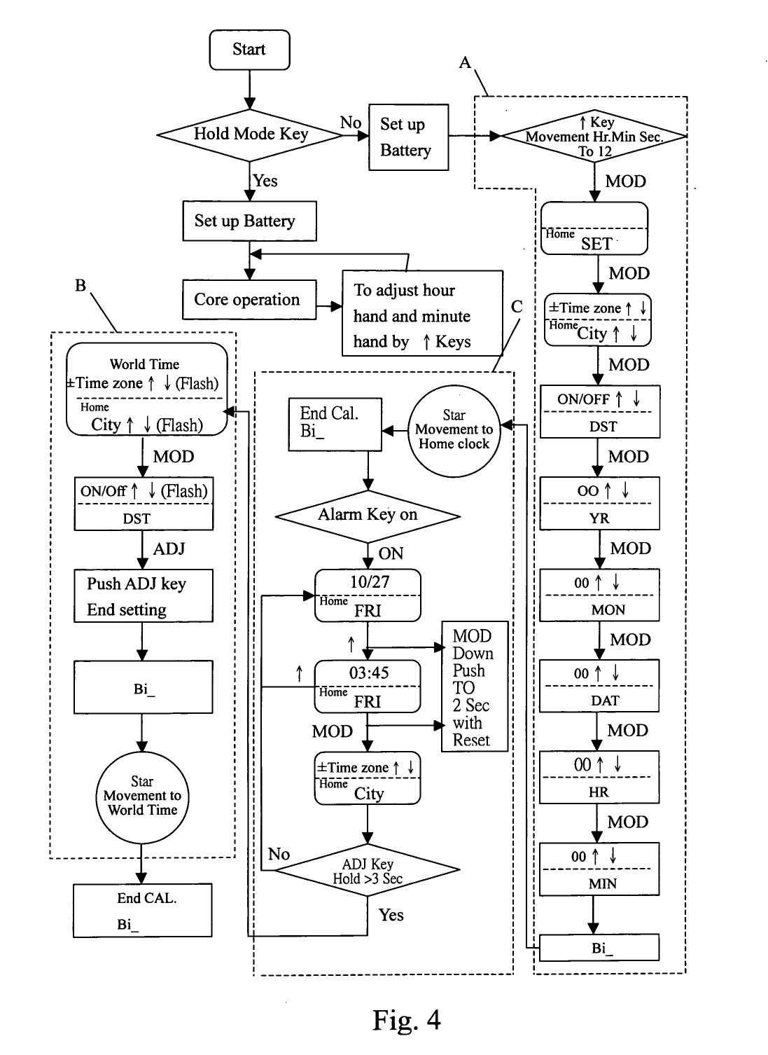

Furthermore, in operation, as shown in FIG. 4, when the present invention is used first time, batteries are installed into the present invention. The liquid crystal time display 14 will display a setup indication so as to reset the unit. When the upward key 122 is pressed, the minute hand 132 is adjusted to a position of twelve o'clock. When a minute hand adjusting button (at a backside of the casing 20, not shown) is adjusted so that the hour hand and minute hand also rotate to the position.

Then, the mode key 121 is pressed. The liquid crystal time display 14 will display the DST adjustment on/off (DST/ON). If the time zone has not in the DST adjustment, the downward key 123 is pressed to turn off the function. Thereby, in DST period (DST), the time will not be adjusted.

If the mode key 121 is pressed further, the liquid crystal time display 14 will display year/00. The upward key 122 or downward key 123 are pressed to set and select a correct year.

Similarly, the mode key 121 is pressed to display the month/00. Then the upward key 122 or the downward key 123 can be pressed to select a correct month.

Then the mode key 121 is pressed to display day/00. Then the upward key 122 or the downward key 123 is pressed to display a correct day.

Then the mode key 121 is pressed to display hour/00. Then the upward key 122 or the downward key 123 is pressed to display a correct hour.

Then the mode key 121 is pressed to display minute/00. Then the upward key 122 or the downward key 123 is pressed to display a correct minute.

Then the mode key 121 is pressed to complete all the setup operations, namely, to perform a reset operation, as shown in part A of FIG. 4. Thus, the display screen will display the correct day and time. Meanwhile, the CPU 11 will calculate the time difference to drive a synchronous motor of the time zone adjusting unit 15 to move the hour hand, minute hand, and second hand to synchronously move to coincide with the setup time so that the hour hand, minute hand and second hour move to a determined position. Thus, the setting operation is complete.

When the user desires to display time of different time zone, it is only necessary to adjust the time zone adjusting unit 15, namely to rotate a rotary disk to a time zone to be display (covering, for example, a city). Then the user select whether the time zone to be displayed is in a DST period. Then the time zone signal and DST selection signal generated from the adjustment of the time zone adjusting unit 15 are inputted into the CPU 11. The CPU 11 will calculate a relative time to emit pulse signals to control the mechanical time display unit and the liquid crystal time display to adjust to the corrected relative time.

Referring to part C in FIG. 4, in the present invention, the selection of world time is executed by keys on a liquid crystal display. This is also a time adjusting device. Thereby, it is not confined by the rotary disk illustrated in FIG. 7.

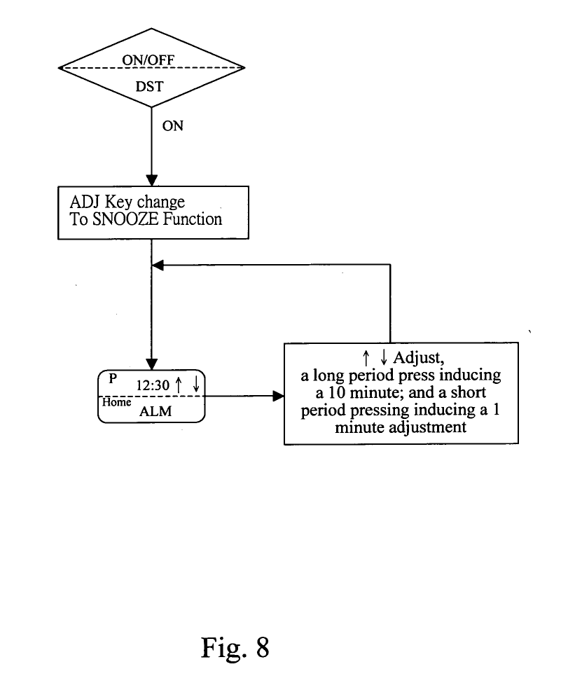

Moreover, in the process shown in FIG. 4, an alarm unit can be added therein, as shown in part C of the drawing. The alarm unit includes an alarm switch 16 and an adjusting key 161, which is similar to the general clock. The operation process is illustrated in FIG. 8.

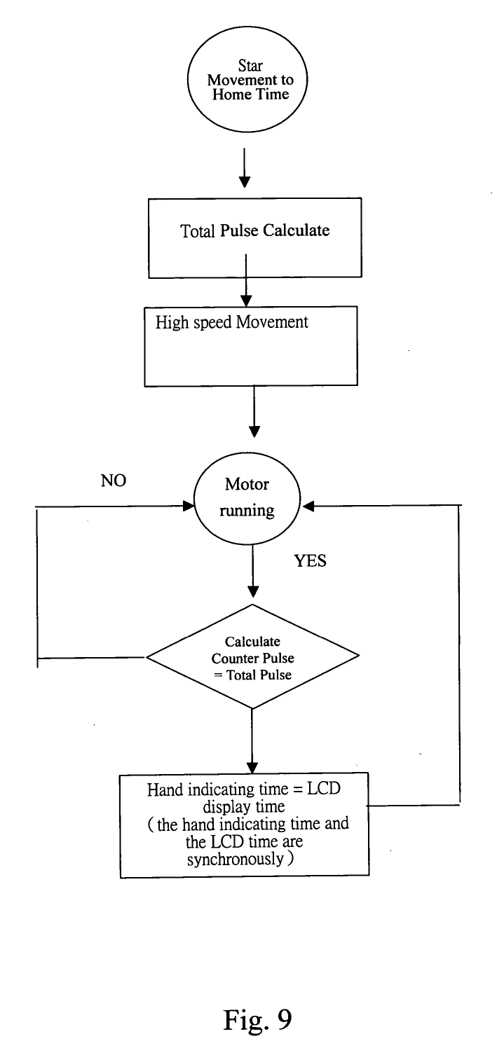

In the mechanical time display unit of the present invention, a synchronous motor serves to push a gear set to move the hour hand, minute hand, and second hand. Then the CPU 11 will receive input signals. After operation, pulse signals are emitted to adjust the time zone adjusting unit 15 to a correct display time by the synchronous motor. Referring to FIG. 9, after operation of the CPU 11, the pulse speed is increased so that movements of the mechanical time display unit (including the hour hand, minute hand, etc.) and the liquid crystal time display are adjusted synchronously.

In above discussion, if it is desired to use the present invention in a only predetermined time zone, then the time zone adjusting unit can be removed and the DST program is set in the CPU 11. Then the present invention can display time with adjustment of the DST. Thereby, no manual adjustment is performed.

The present invention has been described with a preferred embodiment thereof and it is understood that many changes and modifications in the described embodiment can be carried out without departing from the scope and the spirit of the invention as defined by the appended claims.

1. A movement for automatically correcting daylight saving time (DST) comprising:
a time display unit for displaying time;
a central processing unit (CPU) building with a time difference and ST calculating program for calculating correct time and displaying the correct time on the time display unit; and
a time zone adjusting unit installed with 24 time zone segments; as one of the 24 time zone segments being selected, a time zone signal based on the selected time zone section being emitted to the CPU;
wherein the CPU receives the time zone signals from the time zone adjusting unit and calculates a correct time based on the selected time zone section and a DST of the selected time zone, and then control the time display unit to display the correct time.

2. The movement for automatically correcting DST as claimed in claim 1, wherein a calculation of the DST in the DST calculating program is based on the DST of an area in the time zone, which is determined of a nation the area belonged.

3. The movement for automatically correcting DST as claimed in claim 2, wherein when an area in the selected time zone section is in a DST period, the DST calculating program calculates a difference of the DST and then adds the difference to the correct time, the CPU adds DST to a contrast time based on the time zone signal so as to display on the time display unit to display a correct time.

4. The movement for automatically correcting DST as claimed in claim 1, wherein in the DST calculating program, the DST adjustment of U.S. is defined as 02:00 o'clock of the first Sunday of April to 02:00 o'clock of the last Sunday of October and for areas in Europe, the DST adjustment is defined from 02:00 o'clock of the last Sunday of March to 03:00 o'clock, last Sunday of October.

5. The movement for automatically correcting DST as claimed in claim 1, wherein the time display unit is selected from one of a mechanical time display unit and a liquid crystal time display.

6. The movement for automatically correcting DST as claimed in claim 1, wherein the time display unit includes a mechanical time display unit and a liquid crystal time display.

7. The movement for automatically correcting DST as claimed in claim 6, wherein the core further includes a mode selection keys; the mode selection keys include a mode key, an upward key, and a downward key; operations of the mode selection keys will reset the mechanical time display unit and the liquid crystal time display.

8. The movement for automatically correcting DST as claimed in claim 5, wherein the mechanical time display unit has a synchronous motor; the synchronous motor serves to drive a gear set of a hour hand and a minute hand; the CPU controls the synchronous motor by pulses so as to move the hour hand and minute hand; and thus the display time is changed.

9. The movement for automatically correcting DST as claimed in claim 6, wherein the mechanical time display unit has a synchronous motor; the synchronous motor serves to drive a gear set of a hour hand and a minute hand; the CPU controls the synchronous motor by pulses so as to move the hour hand and minute hand; and thus the display time is changed.

10. The movement for automatically correcting DST as claimed in claim 7, wherein the mechanical time display unit has a synchronous motor; the synchronous motor serves to drive a gear set of a hour hand and a minute hand; the CPU controls the synchronous motor by pulses so as to move the hour hand and minute hand; and thus the display time is changed.

11. The movement for automatically correcting DST as claimed in claim 1, furthering comprising an alarm function.

12. A method of displaying a world time with a function of automatic correction of a DST in a movement; the method comprising the step of:
building the core with a time display unit for displaying time; a CPU building with a DST calculating program for calculating correct time and displaying the correct time on the time display unit; and a time zone adjusting unit installed with 24 time zone segments; as one of the 24 time zone segments is selected, a time zone signal based on the selected time zone section being emitted to the CPU;
resetting the time display unit;
determining whether an area for showing the time of the area is in a DST period;
inputting a correct time of a first area and thus completing a setting action;
adjusting the time zone adjusting unit so as to emit time zone signals to the CPU;
the CPU calculating a time difference of a first area and a second area so as to get a time difference between the first and the second area; and getting a DST to get a correct time of the second area and then outputting the correct time to the time display unit; and
the time display unit displaying the correct time including the effect of the DST.

13. The method of displaying a world time with automatic correction of a DST in a movement as claimed in claim 12, wherein the time display unit includes a mechanical time display unit and a liquid crystal time display; the mechanical time display unit has an hour hand and a minute hand.

14. The method of displaying a world time with automatic correction of a DST in a movement as claimed in claim 12, further comprising the step of synchronizing the mechanical time display unit and liquid crystal time display.

15. A movement for automatically correcting DST comprising:
a time display unit for displaying time; wherein
a CPU building with a time difference and DST calculating program for calculating correct time and displaying the correct time on the time display unit;
wherein the CPU determines whether an area to be shown with time of the area is in a DST period so as to display the time of the area to include an effect of the DST period; and a program in the CPU control resets the time of the area to include the DST in a DST period and to remove the DST when the time is out of the DST period.
